(19) United States
(12) Patent Application Publication
(10) Pub. No.: US 2007/0261299 A1
(43) Pub. Date: Nov. 15, 2007

(54) Biodegradable modular roofing tray and method of making

(76) Inventor: Paul Kephart, Carmel Valley, CA (US)

Correspondence Address: Paul Kephart;Rana Creek Habitat Restoration, 35351 East Carmel Valley Road, Carmel Valley, CA, 93924, US

(21) Appl. No.: 11/786,335

(22) Filed: Apr. 10, 2007

Related U.S. Application Data
(60) Provisional application No. 60/797,723, filed on May 4, 2006.

(51) Int. Cl. A01G 9/02

(52) U.S. Cl. 47/65.7; 52/173.1

(57) ABSTRACT

A modular roofing tray made of biodegradable material and impregnated with a biological inoculum to enhance the overall health and welfare of the vegetation planted within.

### FEDERALLY SPONSORED RESEARCH

Not Applicable

### SEQUENCE LISTING OR PROGRAM

Not Applicable

### BACKGROUND

1. Field of the Invention

The present invention generally relates to the field of building materials. More particularly, the present invention relates to the field of roof covering systems and materials using linearly aligned biodegradable modular roofing trays that are designed to hold organic material such as vegetation and which have been impregnated with a biological inoculum to enhance the overall health and welfare of the vegetation planted within such biodegradable modular roofing trays.

2. Description of the Prior Art

Modular Roofing Trays. The building trades industry has made numerous advances in roofing and insulation technology in order to provide and maintain a comfortable interior space in any given building at a commercially reasonable cost. For various reasons, the most attention and, accordingly, the largest number of new developments, has been concentrated in the materials placed in the interior of the building rather than the exterior. Accordingly, the building trades industry has seen an influx of interior insulating materials such as slurried or rolled insulation which is placed in the attic or crawl space directly under the roof. On the other hand, the industry has seen a limited, somewhat smaller number of improvements to insulating materials applied to the exterior of a roofing surface.

As costs for energy increase and, perhaps more important, as concerns for the environment and aesthetic urban planning receive more attention, the building trades industry and the owners of commercial and residential structures, are demanding reasonably priced and energy-efficient means of maintaining a comfortable environment within those structures, particularly in existing structures where the costs of retrofitting the structure with modern technology could be prohibitive.

The industry has begun to address these concerns by adding more external layers of roofing material to increase the insulating effect of the roof structure. However, these additional layers often created weight and moment problems and they did little, if anything to improve the aesthetic appearance of the roof.

However, one example of an improved roof covering and insulation method, vegetation, provides an aesthetically pleasing covering that also keeps the interior of the building cool in the summer and warm in the winter. Further, the use of vegetation as a roof covering provides city planners and architects with an efficient solution that enhances the environment in which building being covered is located. Typically, these modern “turf blankets” use a layer of some type of vegetation growing out of a soil-mix placed on top of a complex system of multi-layered materials to protect the underlying roof structure from water damage and root penetration damage. The vegetation provides color in an otherwise austere urban environment, absorbs urban noise rather than reflecting it, absorbs Carbon Dioxide and other atmospheric pollutants, generates Oxygen, and often provides a haven for various types of flora and fauna.

The prior art shows examples of this approach in U.S. Pat. No. 342,595 issued to Gilman (1886) which discloses a simple roof garden resting on a roof or foundation that is impervious to moisture; European Patent No. 0 204 883 B1 issued to Steinbronn (1993), which discloses a support plate for a plant substrate which serves for making a roof garden; U.S. Pat. No. 5,608,989 issued to Behrens (1997) which discloses a system to support plant growth during the landscaping of an artificial surface; U.S. Pat. No. 5,836,107 also issued to Behrens (1998) which discloses a multi-layered vegetation element for the greening of large rooftops; and U.S. Pat. Nos. 6,178,690 and 6,237,285, both issued to Yoshida et.al. (2001) which disclose a plant cultivation mat to be spread over artificial ground.

While the foregoing solutions represent advances in the field, they tend to be quite expensive and they typically add a significant amount of weight to the roof which, in turn, requires extensive and expensive structural modifications to the roof and the underlying building to prevent the roof and/or building structure from collapsing. Further, the installation of these “turf mats” is cumbersome, time-consuming, and expensive because one layer must be completely in place before work on the next layer can be started. Further still, these systems require the periodic addition of nutritional, pesticidal, and fungicidal supplements to the vegetation layer to promote plant growth and combat invasion from insects, fungus, mites, and other such biological threats to the plant life contained therein.

To address the structural and installation shortcomings inherent in “turf mat” roof systems, the building trades industry began looking at the use of modular components that would place preassembled modules filled with a soil-mix and vegetation growing therein on top of some type of substrate placed on an existing rooftop. The prior art shows examples of this approach in U.S. Design Pat. No. 210,750 issued to Paxton (1968) which discloses a nursery tray; UK Patent Application No. GB 2,138,690A issued to Madden (1984) which discloses a sport turf composed of a plurality of containers each containing turf therein; U.S. Pat. No. 4,926,586 issued to Nagamatsu (1990) which discloses a box for cultivating plants which can be mounted on a roof; PCT Application No. WO 00/69248 submitted by Bindschedler (1999) which discloses a module for producing extensive vegetation on roofs or terraces; U.S. Pat. No. 6,134,834 issued to Ripley, Sr. et.al (2000) which discloses a horticulturally diverse garden having a plurality of transportable modules; Japanese Patent Publication No. 2002070253 filed by Matsushita Electric Works, Ltd. (2002) which discloses a panel for vegetation; U.S. Pat. No. 6,606,823 issued to McDonough et.al. (2003) which discloses a modular roof covering system; and U.S. Pat. No. 6,862,842 issued to Mischo (2005) which discloses a modular green roof system.

The devices disclosed by the foregoing prior art typically address the aforementioned structural issues or concerns by providing a light weight and low cost alternative to a “turf mat” that uses a series of interlocking trays or containers which held several functional layers. These trays are typically ballasted or weighted down or, in the alternative, physically connected to the roof surface on which they are positioned. These trays are typically composed of plastic, polymer, or any lightweight metal which can be fabricated into the desired modular design by standard methods of manufacture for the selected material such as injection molding, stamping, and the like. However, while modern versions of the modular tray concept are simpler than their predecessors, these trays can still be costly to manufacture and difficult to install because of the anchoring requirement. Further, the materials comprising these modular trays and/or their anchors and fasteners (plastics, polymers, metals, and metal alloys) are not biodegradable and, as such, they must be recycled lest they present a threat to the environment or, if manufactured from non-recyclable materials, they will contribute to the growing issue of commercial waste disposal. Further still, these modular systems, like the “turf mats,” require the periodic addition of nutritional, pesticidal, and fungicidal supplements to the vegetation layer to promote plant growth and combat invasion from insects, fungus, mites, and other such biological threats to the plant life contained therein.

Growing Baskets. Growing baskets have been used to decorate homes and businesses for centuries. Typically composed of wood, terra cotta, ceramics, plastic, or other such lightweight and inexpensive materials, these devices have served to provide their owners with a type of portable garden that can be easily placed in most locations on a building. As such, we see growing baskets on window sills, on porches and patios, on fences, on tables and benches, suspended from ceilings, both inside and outside the structure.

Most growing baskets serve as vessels containing a growing medium into which the user introduces a plant of their choice and then tends to that plant by watering, fertilizing, weeding, spraying and the like to ensure that the plant remains healthy and productive. However, the prior art does contain examples of growing baskets that begin to move away from this vessel-plus-growing medium-configuration. U.S. Pat. No. 3,958,365 issued to Proctor (1976) discloses a horticultural aid that is composed of organic or inorganic material that could be combined with an adhesive material and formed in lengths into a ground mat or shaped to cover the soil in prefabricated tubs or baskets, or may be formed into tubs, baskets or pots into which would then be filled with the growing medium. Somewhat later, U.S. Patent Application Publication 2002/0157309 A1 (Wibmer—2003) discloses a coconut fibre planting pot that avoids the poor root penetration and poor decomposition characteristics of more traditional growing baskets. Further, U.S. Patent Application Publication 2003/0140556 A1 (Frogley—2003) discloses a growing medium for plants that can be produced in the form of a self-supporting block that can be used without an additional supporting plant pot or growing basket if desired.

While these devices move the user away from the traditional vessel filled with a growing medium, most are not suitable for use as a building material absent substantial reinforcement which would add significantly to the weight of the individual units and thereby, introducing weight-moment issues discussed previously. Further, while some of these devices are composed of organic material, none teach the interaction of the composite material with the plants or growing medium during the growing process. Further still, none of these devices specifically teach devices which are composed of biodegradable materials.

Biological Inoculum. The term mycorrhiza refers to a symbiotic relationship or association between the hyphae of certain fungi and the absorbing organs (typically the roots) of a plant. This symbiotic relationship takes place at the root level where individual hyphae extending from the mycelium of a fungus colonize the roots of a host plant, either intracellularly or extracellularly. This relationship provides the fungus with a renewable source of food through access to fixed carbons (sugars) from the plant photosynthate. At the same time, it provides the plant with an increased source of inorganic nutrients such as phosphorus and potassium as well as the remaining 13 major macro and micro nutrients necessary for plant growth. The relationship accomplishes this transfer by using the mycelium's tremendous surface area to absorb these mineral nutrients from the surrounding soil. It is believed that the mycelia of mycorrhizal networks have better mineral absorption capabilities as compared to plant roots.

Mycorrhizal plants are often more resistant to diseases such as those caused by microbial soil-borne pathogens. Mycorrhizal roots have a type of protective barrier made up of densely interwove root filaments that effectively acts as a shield against invading root diseases. Furthermore, mycorrhizal fungi, much like white blood cells in the human body, characteristically attack pathogenic or disease-causing organisms entering or approaching the plant's roots.

Given the foregoing, the reader will appreciate that the advantages afforded to plants by this symbiotic relationship will fall into two general categories: those that are agronomic, such as increased growth or yield, and those that are ecological such as improved fitness, improved reproductive ability, improved resistance to diseases such as those caused by microbial and soil-borne pathogens, improved resistance to pests, and improved resistance to environmental hazards such as pollution. In either case, the mycorrhizal plants are generally more competitive and, as such, better able to tolerate and/or overcome environmental stresses than non-mycorrhizal plants. Not surprisingly, practitioners have sought to take advantage of the aforementioned benefits by artificially introducing mycorrhizal fungi into an agricultural environment. However, while the importance of mycorrhizal fungi has been recognized for centuries, the commercial production of mycorrhizal fungi for practical use is a relatively new development. U.S. Pat. No. 4,294,037 issued to Mosse et.al (1981) discloses a process for the production of mycorrhizal fungi which could then be used to produce a mycorrhizal inoculum for incorporation into a plant growth medium to enhance the uptake of nutrients by any plants growing therein. U.S. Pat. No. 4,550,527 issued to Hall et.al (1985) discloses an improved method of infecting the plant roots with the mycorrhizal fungus inoculum by positioning a carrier material carrying the inoculum across the path of the roots. U.S. Pat. No. 5,178,642 issued to Janerette (1993) discloses a process for the production of mycorrhizal fungi which could be then used to produce a mycorrhizal inoculum for incorporation into a plant growth medium to enhance the uptake of nutrients by any leafy (as opposed to woody) plants growing therein.

While the foregoing examples introduce the commercial use of mycorrhizal fungi, the use contemplated by the prior art is limited to that of a biofertilizer for commercially grown agricultural products such as trees, wheat, mushrooms, and the like. In view of the economic incentives for increasing agricultural productivity, this focus is quite understandable, but given the need for environmentally friendly solutions to urban construction, the use of mycorrhizal fungi in building construction materials represents an innovative application of this beneficial symbiotic relationship.

Objects and Advantages. The present invention is a modular roofing tray which addresses the above-mentioned disadvantages and shortcomings by providing a solution that is economical, easy to manufacture, transport, and install, energy efficient, and environmentally friendly. Accordingly, it is an object of the present invention to improve upon modular roof trays known to those skilled in the art by providing a modular roof tray composed of structurally reinforced biodegradable material that has been impregnated with an inoculum that enhances the growth of plants growing therein. Specifically, it is an object of the present invention to:

(1) to provide a modular roof tray that is environmentally friendly, energy efficient, and aesthetically pleasing.

(2) to provide a modular roof tray that is commercially reasonable in price, easy to manufacture, transport, and install.

(3) to provide a modular roof tray that acts as part of an insulating layer to cover the underlying roof and insulate the interior spaces thereunder by keeping them cool in the summer and warm in the winter.

(4) to provide a modular roof tray that acts in conjunction with a layer of vegetation to cover the underlying roof and insulate the interior spaces thereunder by keeping them cool in the summer and warm in the winter.

(5) to provide a modular roof tray that is composed of natural, organic, and hence, biodegradable materials.

(6) to provide a modular roof tray that is composed of materials that are recyclable and biodegradable.

(7) to provide a modular roof tray that is composed of materials that are durable and resistant to deformation.

(8) to provide a modular roof tray that is structurally reinforced to prevent deformation or structural failure.

(9) to provide a modular roof tray that is structurally reinforced with lightweight materials so as to avoid placing additional weight-stress on the structure upon which it is mounted.

(10) to provide a modular roof tray that is composed of materials that are resistant to or inhibit infestation by fungus and/or mites.

(11) to provide a modular roof tray that is composed of materials that have a neutral pH level.

(12) to provide a modular roof tray that is composed of materials that are harvested from sustainable and renewable sources.

(13) to provide a modular roof tray that can be installed over existing roofing materials on existing buildings without structural reinforcement of the existing roof.

(14) to provide a modular roof tray that is composed of materials that are treated with a biological inoculum that supports beneficial and/or native insects indigenous to a particular habitat.

(15) to provide a modular roof tray that is composed of materials that are treated with a biological inoculum that enhances the health and performance of the vegetation planted therein through improved uptake of nutrients.

(16) to provide a modular roof tray that is composed of materials that are treated with a biological inoculum that enhances the health and performance of the vegetation planted therein through increased resistance to disease.

Additional objects, advantages, and novel features of the invention will be set forth in part of the description which follows and will become apparent to those skilled in the art upon examination of the following specification, or will be learned through the practice of the present invention.

### SUMMARY

The present invention is a structurally reinforced modular roofing tray that is made of biodegradable material that has been impregnated with a biological inoculum to enhance the overall health and welfare of the vegetation planted within the roofing tray. It addresses the disadvantages and shortcomings encountered by the prior art by providing an improved modular roofing tray that is economical that is easy to manufacture, transport, and install, that is energy efficient, and that is environmentally friendly.

### DRAWINGS

### DRAWING FIGURES

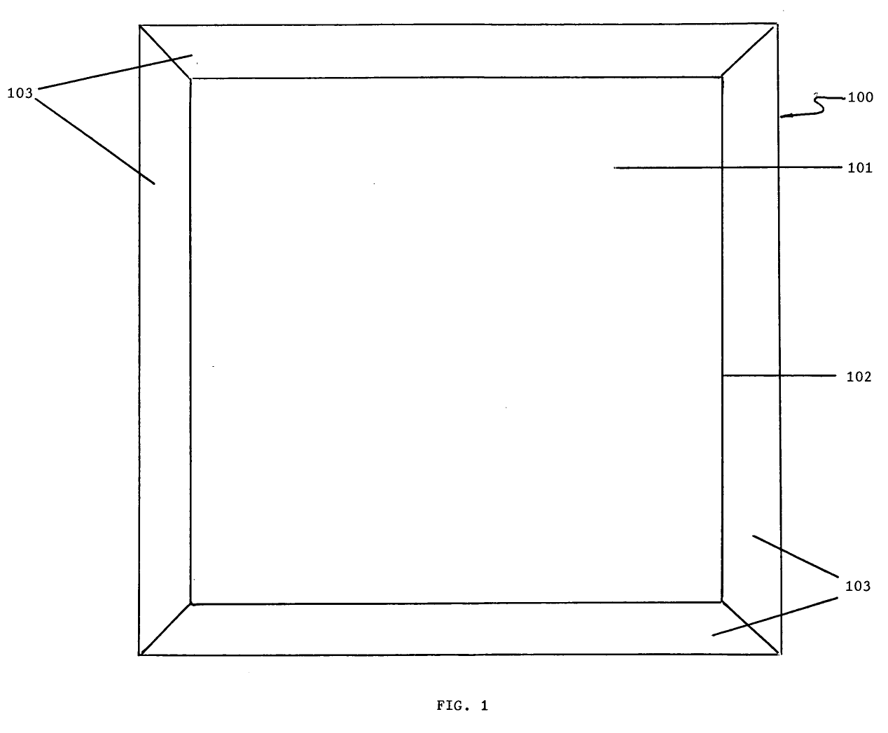

FIG. 1 is a top view of the present invention.

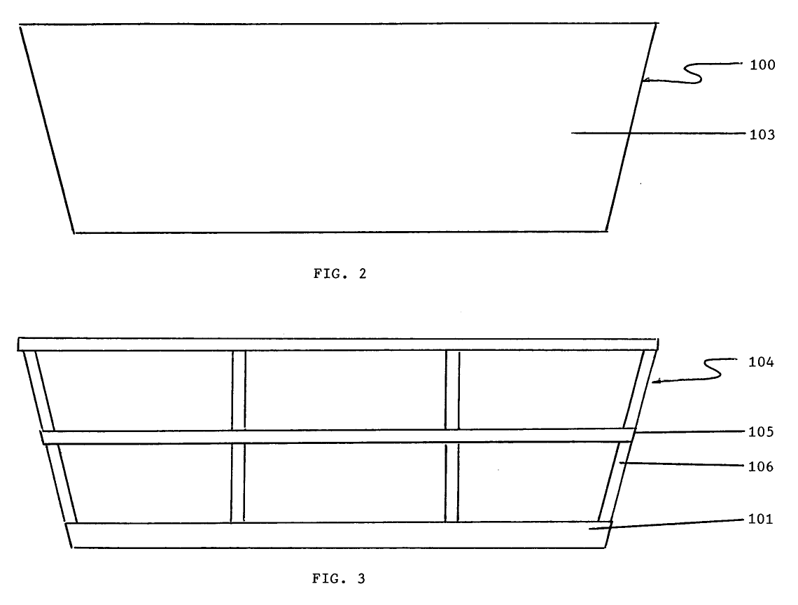

FIG. 2 is a side view of the present invention.

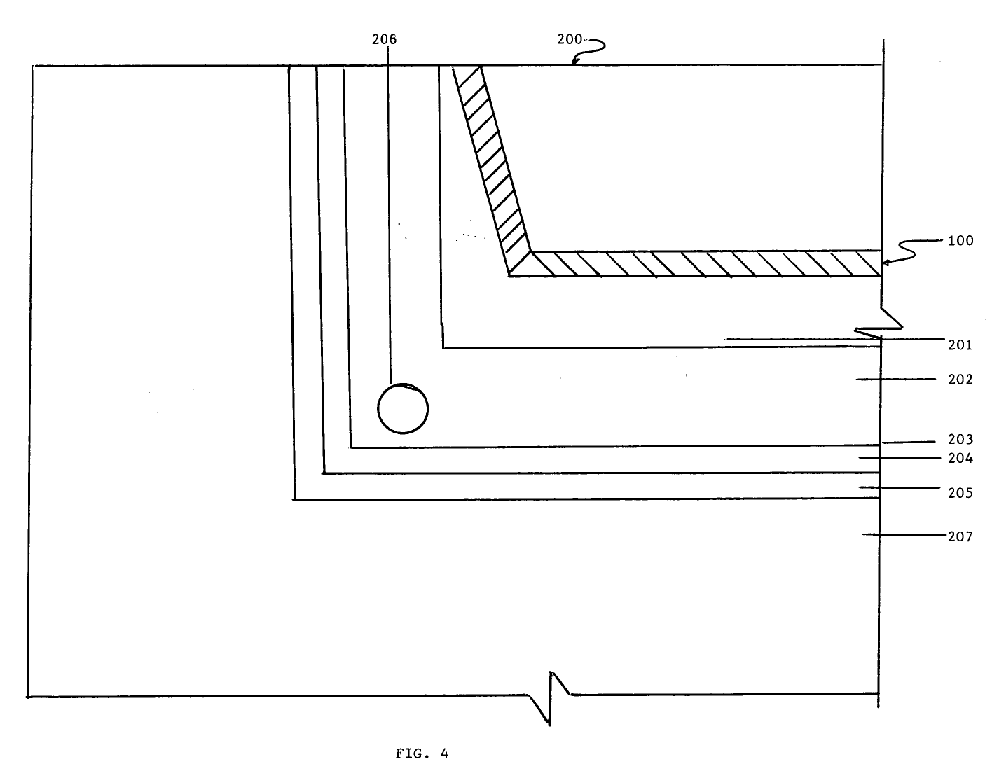

FIG. 3 is a side view of the structural support frame of the present invention.

FIG. 4 is a sectional view the present invention in a typical roof system.

### REFERENCE NUMERALS IN DRAWINGS

100—tray
101—base
102—outer periphery
103—sides
104—skeletal support structure
105—horizontal structural member
106—vertical structural member
200—modular roof system
201—soil-mix layer
202—drain band
203—filter fabric
204—root barrier
205—waterproof membrane
206—perforated pipe
207—roof structure

### DESCRIPTION OF THE INVENTION

Description—Preferred Embodiment. FIG. 1 and FIG. 2 show the preferred embodiment of the present invention which consists of a three-dimensional tray 100 with a rectangular base 101 having an outer periphery 102 and four sides 103 extending upwardly and outwardly from outer periphery 102 of rectangular base 101.

Rectangular base 101 and sides 103 are composed of a composite material containing 70-80% (by weight) sterilized, neutral pH coconut fibers and 20-30% (by weight) natural, vulcanized latex. While a pH of 6.5 to 7.0 is ideal, pH values in the range of 5.5 to 8.0 are acceptable. FIG. 3 shows a rigid skeletal support structure 104 to which this composite material is superimposed upon and attached to skeletal support structure 104 using any commercially available nontoxic adhesive or bonding agent and in such a manner that, when construction of tray 100 is completed, skeletal support structure 104 is actually embedded within rectangular base 101 and sides 103. The preferred embodiment contemplates rectangular base 101 and sides 103 having an optimal composition of approximately 70% coconut fibers by weight and approximately 30% natural, vulcanized latex by weight, but any combination using 70-80% coconut fibre and 20-30% natural, vulcanized latex will be acceptable. The standard size of tray 100 currently used in the building construction industry is 17 inches wide by 17 inches long by three inches deep but the size can vary according to the specific needs of the user.

Referring again to FIG. 3, rigid skeletal support structure 104 is composed of horizontal structural members 105 and vertical structural members 106 both of which are free of toxic laminates and composed of any type of rigid, lightweight, renewable wood such as, without limitation, hickory, permanently held together and fastened using a toxic-free glue or bonding agent.

The base 101 and sides 103 of the preferred embodiment of the present invention are impregnated with a mycorrhizal biological inoculum through injection, saturation, or some other suitable means of introducing the mycorrhizal biological inoculum into the coconut fibers. Mychorrizal associations vary widely in form, structure and function, and the number of combinations and permutations of various beneficial species is quite large. The present invention contemplates the full spectrum of possible combinations and permutations of beneficial species as well as several specific combinations which have been specifically identified as particularly effective. Accordingly, the present invention contemplates biodegradable modular roofing trays, with and without structural support, and containing:

1. Impregnation with any mycorrhizal inoculum.

2. Impregnation with a mycorrhizal inoculum containing at least one beneficial endocorhizal or ectocorhizal species, at least one beneficial Trichoderma species, at least one beneficial Bacterial species, aureofaceans, and Deinococcus erythromyxa.

3. Impregnation with a mycorrhizal inoculum containing:
a. at least one beneficial endocorhizal or ectocorhizal species from the group containing Glomus intraradices, Glomus mosseae, Glomus aggregatum, Glomus clarum, Glomus deserticola, Glomus etunicatum, Gigaspora margarita, Rhizopogon villosullus, Rhizopogon luteolus, Rhizopogon amylopogon, Rhizopogon fulvigleba, Pisolithud tinctorius, Laccaria lacata, Laccari bicolor, Suillus granulatus, and Suillus puntatapies,
b. at least one beneficial Trichoderma species from the set containing Trichoderma harzianum and Trichoderma konigii,
c. at least one beneficial Bacterial species from the group containing Bacillus subtillus, Bacillus lichenformis, Bacillus azotoformans, Bacillus megaterium, Bacillus coagulans, Bacillus pumlis, Bacillus thurengiensis, Bacillus stearothermiphilis, Paenibacillus polymyxa, Paenibacillus durum, Paenibacillus florescence, Paenibacillus gordonae, Azotobacter polymyxa, Azotobacter chroococcum, Sacchtomyces cervisiae, Streptomyces griseues, Streptomyces lydicus, Pseudomonas aureofaceans, and Deinococcus erythromyxa,
d. aureofaceans, and
e. Deinococcus erythromyxa.

4. Impregnation with a mixture containing mycorrhizal biological inoculum propagules in the range of 90 million to 150 million propagules per pound of this mixture with the particle size smaller than 212 microns and the inoculum composed of:
a. endocorhizal or ectocorhizal species from the group containing Glomus intraradices, Glomus mosseae, Glomus aggregatum, Glomus clarum, Glomus deserticola, Glomus etunicatum, Gigaspora margarita, Rhizopogon villosullus, Rhizopogon luteolus, Rhizopogon amylopogon, Rhizopogon fulvigleba, Pisolithud tinctorius, Laccaria lacata, Laccari bicolor, Suillus granulatus, and Suillus puntatapies,
b. at least one beneficial Trichoderma species from the set containing Trichoderma harzianum and Trichiderma konigii,
c. at least one beneficial Bacterial species from the group containing Bacillus subtillus, Bacillus lichenformis, Bacillus azotoformans, Bacillus megaterium, Bacillus coagulans, Bacillus pumlis, Bacillus thurengiensis, Bacillus stearothermiphilis, Paenibacillus polymyxa, Paenibacillus durum, Paenibacillus florescence, Paenibacillus gordonae, Azotobacter polymyxa, Azotobacter chroococcum, Sacchtomyces cervisiae, Streptomyces griseues, Streptomyces lydicus, Pseudomonas aureofaceans, and Deinococcus erythromyxa,
d. aureofaceans, and
e. Deinococcus erythromyxa.

While the mycorrhizal biological inoculum present the user with many benefits, other bacteriological inocula from the same or similar families may be used to impregnate the coconut fibers to optimize interaction with a specific habitat. The biological inoculum serves to enhance the health of vegetation planted in tray 100 through increased resistance to disease, improved uptake of nutrients, and the support of beneficial native insects indigenous to a particular habitat.

Over time, the roots of the vegetation planted in tray 100 will thoroughly penetrate the coconut fiber and ultimately incorporate the fiber by turning it into nutrients. Trays 100 are durable enough to remain structurally intact during installation upon a given roof area but because of the biodegradable materials which comprise the trays 100, trays 100 eventually break down and become part of the underlying soil strata.

Description—Alternative Embodiment. A simpler embodiment of the present invention contemplates molding rectangular tray 100 around a rectangular block thereby eliminating the need for rigid support structure 104. Other embodiments of the present invention contemplate the use of biodegradable materials other than the coconut fiber and natural, vulcanized latex composite described herein.

Description—Preferred Embodiment in a Roofing System and a Landscaping System. FIG. 4 shows the present invention as part of a modular roof covering and insulating system 200. When used in this manner, tray 100 is filled with vegetation planted in some growing medium such as soil, wood chips, or the like and then placed in a soil-mix layer 201. The soil-mix layer is typically six to eight inches deep and lays over a drain band 202 composed of coarsely crushed rock, brick, or other such porous material that will permit water to percolate downward and be drained off through perforated pipe 206 which could also be used to irrigate modular roof system 200. A filter fabric 203 keeps particulate matter percolating through drain band 202 from settling on the root barrier 204 which is in place to keep downward growing roots from growing into cracks in the roof structure 207. A waterproof membrane 205 is placed beneath root barrier 204 to keep water from settling upon and ultimately damaging roof structure 207.

The tray 100 is constructed of biodegradable materials so that, over time, it will decompose and become integrated into the soil mix layer 201 thereby eliminating the need to dispose of the tray 100 when it is no longer needed. The tray 100 has also been impregnated with a mycorrhizal fungi inoculum which will interact with the vegetation planted in the growing medium so as to enhance its ability to take nutrients from the growing medium and soil-mix layer 210. The mycorrhizal fungi inoculum will also make such vegetation more resistant to diseases such as those caused by microbial soil-borne pathogens. Further, mycorrhizal roots have a type of protective barrier made up of densely interwove root filaments that effectively acts as a shield against invading root diseases. Furthermore, mycorrhizal fungi, much like white blood cells in the human body, characteristically attack pathogenic or disease-causing organisms entering or approaching the plant's roots. The end result is healthier, longer-lasting vegetation insulating roof structure 207 without the need for additives to the growing medium or disposal of the tray 100 containing the healthier vegetation.

Tray 100 can also be used in landscape design. The tray(s) 100 is (are) simply placed in a shallow excavation at the desired location and then left alone. Since the tray 100 is manufactured from biodegradable materials, it will eventually become integrated with the underlying soil. Since the tray 100 is also impregnated with a mycorrhizal fungi inoculum which will interact with the vegetation planted in the growing medium so as to enhance its ability to take nutrients from the growing medium and the underlying soil. The tray 100 can be customized and shaped to fit a particular location as desired by the user.

Description: Manufacturing Process. The manufacture of the present invention is quite simple and straightforward. The first step is sterilizing the biodegradable and pH neutral coconut fibers in an autoclave or other sterilization vessel at a temperature of 110 degrees Fahrenheit or higher. While a pH of 6.5 is ideal, plants perform well when the pH is in the range of 5.5 to 8.0. The sterilized coconut fiber is then combined with natural vulcanized latex so as to form a composite mixture that is pliable enough to be rolled or extruded into flat sheets approximately two inches in thickness. The composite mixture is then molded around a box-like three-dimensional skeletal support structure consisting of horizontal and vertical structural members that are free of toxic laminates and composed of any type of rigid, lightweight, and renewable wood. These horizontal and vertical structural members are permanently held together and fastened using toxic-free glue so as to form this rectangular skeletal support structure. The modular tray is then dried to ensure that the composite mixture is free of moisture and firmly attached to and secured to said skeletal structure. Once the rectangular tray is dry, it is impregnated with a biological inoculum.

Conclusions, Ramifications, and Scope. The present invention uses three diverse concepts, roofing modules, growing boxes, and fungal inoculum, to deliver a unique building product that is environmentally friendly, energy efficient, aesthetically pleasing, commercially reasonable in price, and easy to manufacture, transport, and install. Specifically, the present invention:
is aesthetically and visually pleasing.
is composed of natural, organic, and hence, biodegradable materials.
is composed of materials that are recyclable and biodegradable.
is composed of materials that are durable and resistant to deformation.
is structurally reinforced to prevent deformation or structural failure.
is structurally reinforced with lightweight materials so as to avoid placing additional weight-stress on the structure upon which it is mounted.
is composed of materials that are resistant to or inhibit infestation by fungus and/or mites.
is composed of materials that have a neutral pH level.
is composed of materials that are harvested from sustainable and renewable sources.
can be installed over existing roofing materials on existing buildings without structural reinforcement of the existing roof.
acts as part of an insulating layer to cover the underlying roof and insulate the interior spaces thereunder by keeping them cool in the summer and warm in the winter.
acts in conjunction with a layer of vegetation to cover the underlying roof and insulate the interior spaces thereunder by keeping them cool in the summer and warm in the winter.
is composed of materials that are treated with a biological inoculum that supports beneficial and/or native insects indigenous to a particular habitat.
is composed of products that are treated with a biological inoculum that enhances the health and performance of the vegetation planted therein through improved uptake of nutrients.
is composed of materials that are treated with a biological inoculum that enhances the health and performance of the vegetation planted therein through increased resistance to disease.

What is claimed is:

1. A biodegradable modular roofing tray comprised of a rectangular base and four sides extending vertically upward and outward from the outer periphery of said rectangular base, with said rectangular base and said sides composed of a mixture consisting of 70 to 80 per cent sterilized coconut fibers having a pH in the range of 5.5 to 8.0 and 20 to 30 per cent natural, vulcanized latex held together by a nontoxic adhesive agent.

2. The biodegradable modular roofing tray according to claim 1 wherein said tray is impregnated with a biological inoculum.

3. The biodegradable modular roofing tray according to claim 1 wherein said tray is impregnated with mycorrhizal biological inoculum.

4. The biodegradable modular roofing tray according to claim 1 wherein said tray is impregnated with mycorrhizal biological inoculum containing at least one beneficial endocorhizal or ectocorhizal species, at least one beneficial Trichoderma species, at least one beneficial Bacterial species, aureofaceans, and Deinococcus erythromyxa.

5. The biodegradable modular roofing tray according to claim 1 wherein said tray is impregnated with mycorrhizal biological inoculum containing:
a. at least one beneficial endocorhizal or ectocorhizal species from the group consisting of Glomus intraradices, Glomus mosseae, Glomus aggregatum, Glomus clarum, Glomus deserticola, Glomus etunicatum, Gigaspora margarita, Rhizopogon villosullus, Rhizopogon luteolus, Rhizopogon amylopogon, Rhizopogon fulvigleba, Pisolithud tinctorius, Laccaria lacata, Laccari bicolor, Suillus granulatus, and Suillus puntatapies,
b. at least one beneficial Trichoderma species from the group consisting of Trichoderma harzianum and Trichoderma konigii,
c. at least one beneficial Bacterial species from the group consisting of Bacillus subtillus, Bacillus lichenformis, Bacillus azotoformans, Bacillus megaterium, Bacillus coagulans, Bacillus pumlis, Bacillus thurengiensis, Bacillus stearothermiphilis, Paenibacillus polymyxa, Paenibacillus durum, Paenibacillus florescence, Paenibacillus gordonae, Azotobacter polymyxa, Azotobacter chroococcum, Sacchtomyces cervisiae, Streptomyces griseues, Streptomyces lydicus, Pseudomonas aureofaceans, and Deinococcus erythromyxa,
d. aureofaceans, and
e. Deinococcus erythromyxa.

6. The biodegradable modular roofing tray according to claim 1 wherein said tray is impregnated with mycorrhizal biological inoculum propagules in the range of 90 million to 150 million propagules per pound of said mixture and said inoculum composed of:
a. endocorhizal or ectocorhizal species from the group consisting of Glomus intraradices, Glomus mosseae, Glomus aggregatum, Glomus clarum, Glomus deserticola, Glomus etunicatum, Gigaspora margarita, Rhizopogon villosullus, Rhizopogon luteolus, Rhizopogon amylopogon, Rhizopogon fulvigleba, Pisolithud tinctorius, Laccaria lacata, Laccari bicolor, Suillus granulatus, and Suillus puntatapies,
b. at least one beneficial Trichoderma species from the group consisting of Trichoderma harzianum and Trichiderma konigii,
c. at least one beneficial Bacterial species from the group consisting of Bacillus subtillus, Bacillus lichenformis, Bacillus azotoformans, Bacillus megaterium, Bacillus coagulans, Bacillus pumlis, Bacillus thurengiensis, Bacillus stearothermiphilis, Paenibacillus polymyxa, Paenibacillus durum, Paenibacillus florescence, Paenibacillus gordonae, Azotobacter polymyxa, Azotobacter chroococcum, Sacchtomyces cervisiae, Streptomyces griseues, Streptomyces lydicus, Pseudomonas aureofaceans, and Deinococcus erythromyxa,
d. aureofaceans, and
e. Deinococcus erythromyxa.

7. The biodegradable modular roofing tray according to claim 1 wherein said rectangular base and said sides are superimposed upon and attached to a semi-rigid skeletal support structure, said skeletal support structure having horizontal and vertical structural members composed of any type of renewable wood, said horizontal and vertical structural members held together by any type of nontoxic bonding agent.

8. The biodegradable modular roofing tray according to claim 7 wherein said tray is impregnated with a biological inoculum.

9. The biodegradable modular roofing tray according to claim 7 wherein said tray is impregnated with mycorrhizal biological inoculum.

10. The biodegradable modular roofing tray according to claim 7 wherein said tray is impregnated with mycorrhizal biological inoculum containing at least one beneficial endocorhizal or ectocorhizal species, at least one beneficial Trichoderma species, at least one beneficial Bacterial species, aureofaceans, and Deinococcus erythromyxa.

11. The biodegradable modular roofing tray according to claim 7 wherein said tray is impregnated with mycorrhizal biological inoculum containing:
a. at least one beneficial endocorhizal or ectocorhizal species from the group consisting of Glomus intraradices, Glomus mosseae, Glomus aggregatum, Glomus clarum, Glomus deserticola, Glomus etunicatum, Gigaspora margarita, Rhizopogon villosullus, Rhizopogon luteolus, Rhizopogon amylopogon, Rhizopogon fulvigleba, Pisolithud tinctorius, Laccaria lacata, Laccari bicolor, Suillus granulatus, and Suillus puntatapies,
b. at least one beneficial Trichoderma species from the group consisting Trichoderma harzianum and Trichiderma konigii,
c. at least one beneficial Bacterial species from the group consisting of Bacillus subtillus, Bacillus lichenformis, Bacillus azotoformans, Bacillus megaterium, Bacillus coagulans, Bacillus pumlis, Bacillus thurengiensis, Bacillus stearothermiphilis, Paenibacillus polymyxa, Paenibacillus durum, Paenibacillus florescence, Paenibacillus gordonae, Azotobacter polymyxa, Azotobacter chroococcum, Sacchtomyces cervisiae, Streptomyces griseues, Streptomyces lydicus, Pseudomonas aureofaceans, and Deinococcus erythromyxa,
d. aureofaceans, and
e. Deinococcus erythromyxa.

12. The biodegradable modular roofing tray according to claim 7 wherein said tray is impregnated with mycorrhizal biological inoculum propagules in the range of 90 million to 150 million propagules per pound of said mixture and said inoculum composed of:
a. endocorhizal or ectocorhizal species from the group consisting of Glomus intraradices, Glomus mosseae, Glomus aggregatum, Glomus clarum, Glomus deserticola, Glomus etunicatum, Gigaspora margarita, Rhizopogon villosullus, Rhizopogon luteolus, Rhizopogon amylopogon, Rhizopogon fulvigleba, Pisolithud tinctorius, Laccaria lacata, Laccari bicolor, Suillus granulatus, and Suillus puntatapies,
b. at least one beneficial Trichoderma species from the group consisting of Trichoderma harzianum and Trichoderma konigii,
c. at least one beneficial Bacterial species from the group consisting of Bacillus subtillus, Bacillus lichenformis, Bacillus azotoformans, Bacillus megaterium, Bacillus coagulans, Bacillus pumlis, Bacillus thurengiensis, Bacillus stearothermiphilis, Paenibacillus polymyxa, Paenibacillus durum, Paenibacillus florescence, Paenibacillus gordonae, Azotobacter polymyxa, Azotobacter chroococcum, Sacchtomyces cervisiae, Streptomyces griseues, Streptomyces lydicus, Pseudomonas aureofaceans, and Deinococcus erythromyxa,
d. aureofaceans, and
e. Deinococcus erythromyxa.

13. A method of manufacturing biodegradable modular roofing trays comprising the steps of:
a. sterilizing biodegradable coconut fiber in an autoclave or other sterilization vessel,
b. combining said coconut fiber with natural vulcanized latex so as to form a composite mixture,
c. molding said composite mixture onto a box-like three-dimensional skeletal support structure comprised of horizontal and vertical structural members free of toxic laminates and composed of any type of rigid, lightweight, and renewable wood, said horizontal and vertical structural members permanently held together and fastened using toxic-free glue,
d. drying said composite mixture, and
e. impregnating said composite mixture with a biological inoculum.
